(19) United States
(12) Patent Application Publication
(10) Pub. No.: US 2008/0140233 A1
(43) Pub. Date: Jun. 12, 2008

(54) DETERMINING TEAM EFFECTIVENESS THROUGH SPORTING EVENTS

(75) Inventor: Lisa A. Seacat, San Francisco, CA (US)

Correspondence Address: MOLLBORN PATENTS;ATTN: IBM, 2840 COLBY DRIVE, BOULDER, CO, 80305, US

(73) Assignee: INTERNATIONAL BUSINESS MACHINES CORPORATION, Armonk, NY (US)

(21) Appl. No.: 11/609,623

(22) Filed: Dec. 12, 2006

(51) Int. Cl. G06F 19/00

(52) U.S. Cl. 700/91

(57) ABSTRACT

Methods and apparatus, including computer program products, implementing and using techniques for analyzing team effectiveness for a sports team, based at least in part on information obtained from an ongoing sports game. Location data is generated by tracking a location for at least some players in the sports team during the ongoing sports game. The location data is processed in real time in a computer to determine a team effectiveness for the sports team. A system for analyzing team effectiveness for a sports team, based at least in part on information obtained from an ongoing sports game is also described.

### BACKGROUND

This invention relates to computer applications for analyzing sports teams. One important task for a team coach is to monitor and stay updated about how the different players on his team perform and interact with each other. The coach can then apply this information in creating the best possible setup of the team in any given situation, for the purpose of increasing the team's chances of winning the game. This general principle can be applied to most, if not all, team sports.

A common method of monitoring the effectiveness of various players and plays or team setups under different circumstances is to analyze tapes of previous games. By studying these recordings, the coach can obtain information about the players both on an individual level and about how they interact in various situations. While these types of studies can provide large amounts of information about the strengths and weaknesses of the coach's team and its individual players, studying this footage is very time consuming.

Various attempts have been made to make this analysis more automatic and reduce the time the coaches have to spend doing such analysis. One such analysis tool is a computer program, Zeus™, developed by End Game Technologies LLC, which models and predicts the outcomes of coaching decisions in American football games. The program uses a database of up-to-date NFL statistics to produce a prediction to the user about how a specific play will increase or decrease the team's chances of winning a game. The program is particularly geared toward evaluating “binary” situations where a coach has essentially two or three play decisions which the opposing team will recognize.

While this type of computer program can be very helpful to a team coach, it is based on old information about players and conditions obtained from a database and does not take into account the specifics of an ongoing game. Thus it would be desirable to have a better and more accurate way to predict team effectiveness that is at least in part based on the present conditions in an ongoing game.

### SUMMARY

In general, in one aspect, the invention provides methods and apparatus, including computer program products, implementing and using techniques for analyzing team effectiveness based at least in part on information obtained from an ongoing sports game. Location data is generated by tracking a location for at least some players in the sports team during the ongoing sports game. The location data is processed in real time in a computer to determine a team effectiveness for the sports team.

In general, in another aspect, the invention provides a system for analyzing team effectiveness for a sports team, based at least in part on information obtained from an ongoing sports game. The system includes one or more radio frequency identification tags, one or more radio frequency identification readers, and a computer. Each radio frequency identification tag is associated with the physical location of a player in the sports game. The radio frequency identification readers determine the location of the radio frequency identification tags, read information stored in the radio frequency identification tags and transmit the location and read information to the computer for further processing. The computer receives the transmitted information from the radio frequency identification readers, applies a set of rules to the received information in real time to analyze specifics of the ongoing sports game, and produces a graphical output of the results from the analysis to a user on a display screen.

The invention can be implemented to include one or more of the following advantages. By analyzing RFID information from the team members' equipment, it is possible to obtain current information about each player and how the player interacts with other players. This makes it possible to perform a more accurate analysis that is appropriate for current conditions, compared to an analysis that only uses historical data from a database, and can thus serve as a better aid to coaches in making decisions about the team's composition and various play situations. If properly used, the results of this analysis can increase a team's chances of winning a game. A coach can quickly view statistics and probable outcomes, not only from running one play over another play, but also the probable change in such a decision based on substituting one player for another player. The RFID information can also be used to overlay the routes of players on a television screen. This provides a convenient way for network broadcasting channels to show which players went which way during a given time period of a sports game, and can further enhance the viewing experience of the network's viewers.

The details of one or more embodiments of the invention are set forth in the accompanying drawings and the description below. Other features and advantages of the invention will be apparent from the description and drawings, and from the claims.

### DESCRIPTION OF DRAWINGS

FIG. 1 shows a schematic diagram of a football field with players and RFID transmitters in a system in accordance with one embodiment of the invention.

FIG. 2 is a schematic flowchart of a player data evaluation process in accordance with one embodiment of the invention.

Like reference symbols in the various drawings indicate like elements.

### DETAILED DESCRIPTION

The present invention provides methods and apparatus, including computer program products, for monitoring and analyzing team effectiveness based at least in part on information obtained from an ongoing sports game. In accordance with the various embodiments of the invention, the players on the team are equipped with Radio Frequency Identification (RFID) tags. RFID readers capable of reading the information stored in the players' RFID tags are placed along the sports field. The RFID readers monitor the locations of the players and transmit the location information to a computer or server that is equipped with software for processing the location data. The software applies a set of rules to the received location data to evaluate how well individual players and/or the team as a whole play.

In some embodiments, the software can propose different team setups and/or plays based on current performance data and/or historical data from previous plays. As a result, the software can present the coach with options that she may have overlooked, and which can improve the team's chances of winning the game. The RFID information and the software can also be used by, for example, newscasters or commentators watching the sports game, who can use the information to predict what the coach will do next in a certain situation or speculate about what would happen if the team setup changed, and so on. This can provide a better viewing experience for the people watching the game on their television sets. In some embodiments, the RFID information can be transmitted to a live gaming system and be presented in real time. The various embodiments of the invention will now be described in further detail with reference to the drawings. It should however be realized, that this is no exhaustive description of the various embodiments of the current invention and that the scope of this application is defined by the claims rather than the subsequent examples.

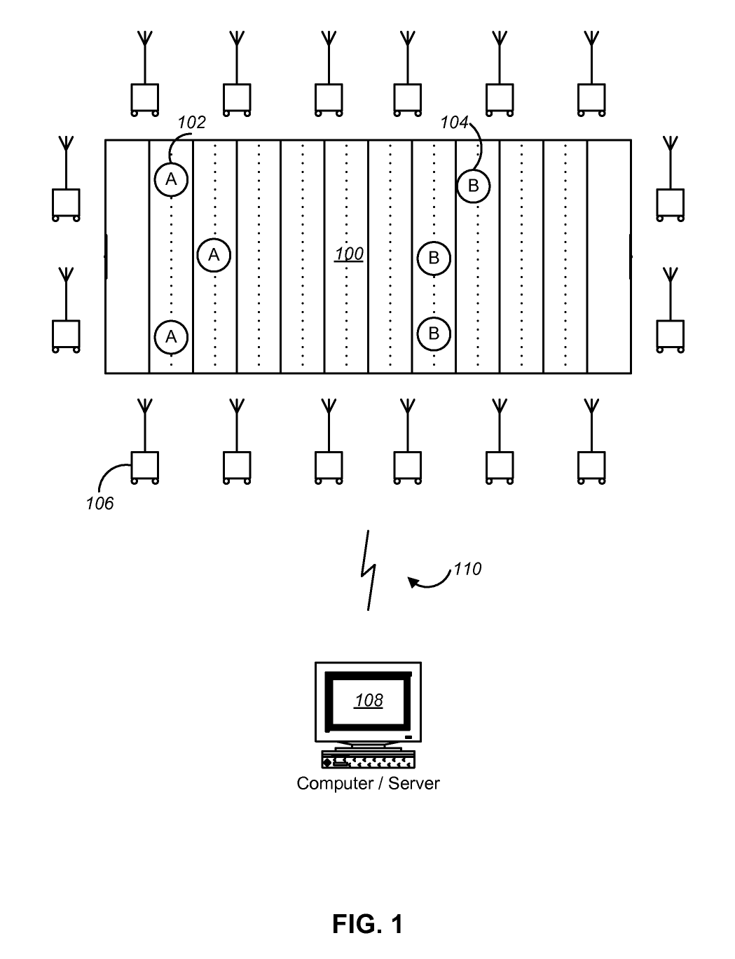

FIG. 1 shows a schematic view of a sports field (100), in this case a football field, on which two teams, Team A (102) and Team B (104) are present playing a game. The system and methods of the various embodiments of the invention will be described with reference to Team A. Each player (102) in Team A has an RFID tag mounted in some piece of clothing or equipment, such as the player's helmet, shirt, shoes, and so on. As is well known by those of ordinary skill in the RFID art, the RFID tag can be active or passive and store a variety of information, such as the player's name, number, position on the team, player statistics from previous games, the player's ranking in the league, and so on. In some embodiments, the RFID tag also stores various trivia about the player, such as the player's Alma Mater, the player's home town, favorite ice cream, and essentially anything else that may be of interest to someone watching the game.

A set of RFID readers (106) are placed along the field (100). The RFID readers (106) determine the location for each player and decode the data encoded in each player's RFID tag's integrated circuit (silicon chip) and pass the data to a host computer or server (108), over a wireless or wired network connection (110). In some embodiments, the location of each player, as determined by the RFID readers (106), is expressed as coordinates in a coordinate system. In some embodiments RFID readers (106) are configured to express the player's coordinates in a coordinate system that is specific to the court or field where the ongoing sports game is taking place. In other embodiments, the RFID readers (106) are configured to express the player's location as latitude and longitude coordinates. In yet other embodiments, a separate location tracking system, such as a global positioning system (GPS) can be used to provide the locations of each player, which can then be correlated with the RFID tag data that is read by the RFID readers (106) into location data for further processing.

In some embodiments of the invention, the data transmission from the RFID readers (106) is encoded, so that only the coach of Team A can receive and process the information. In other embodiments, the transmission is not encoded, so that the location data and the RFID tag data is also available to the general public and to, for example, television broadcasting companies who can further process the data to enhance the television broadcast, as will be exemplified below. The RFID readers (106) are shown in FIG. 1 as being located around the sports field (100). However, the RFID readers (106) can also be placed on the surface of the sports field itself, be embedded within the turf, or even be suspended above the field similar to the way television cameras are suspended in many sports arenas. In some embodiments the RFID readers (106) are networked and collaborate to report the location of each player (102) in Team A on the field (100) at any given moment.

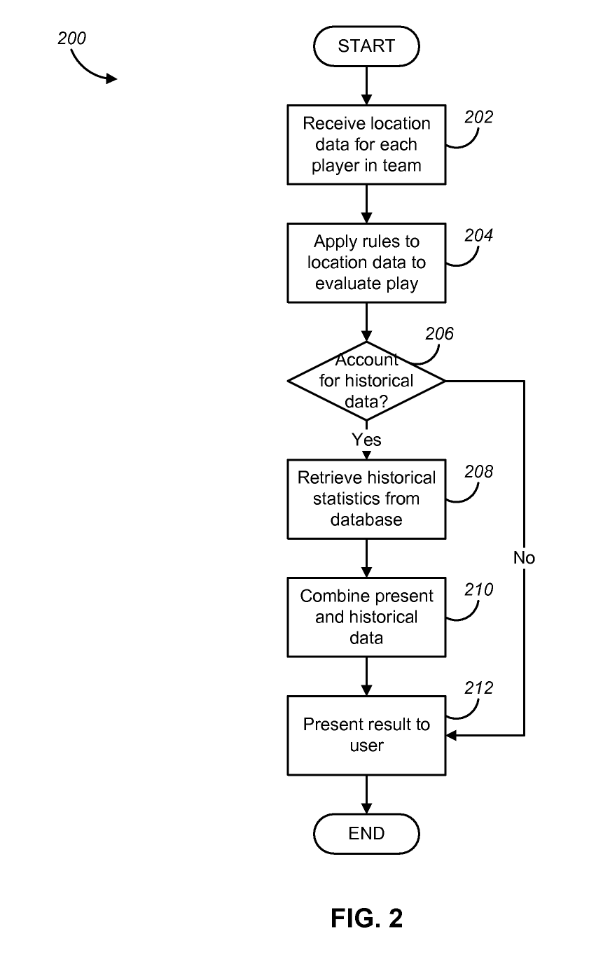

The computer or server (108) contains hardware and software that can perform various types of analyses, based on the received location information for the players (102) in Team A. The processing in the computer (108) will now be described in further detail with reference to FIG. 2. It should be noted that the processing described in FIG. 2 occurs in real time, that is, as the sports game is being played and as location data is received from the RFID readers (106) such that the information is available immediately. However, in some embodiments, the location data is also stored such that it can be processed after the game or re-analyzed in further detail.

As can be seen in FIG. 2, the process first receives location data for each player (102) in Team A (step 202) from the RFID readers (106), as described above. Next, the process applies a set of rules to the location data to evaluate the play (step 202). As is evident to those of ordinary skill in the art, the set of rules that is selected is specific to the particular sport, for example, when a soccer game is evaluated, a different set of rules has to be applied, compared to, say, when a football game is evaluated.

Furthermore, the rules are selected in step 204 based on what type of analysis is performed. For example, in a football game, the rules can be applied to evaluate offensive and defensive plays to determine how often the plays were successful. If the location information indicates that the players on the team are moving towards their goal, for example, then the players are defending their goal and are therefore on defense, and if they are moving away from their goal, then the players are on offense. If a defensive play results in a quarterback sack, loss in yards, or an interception, then the defensive play can be considered successful. In some embodiments, the rules can overlay a given play's planned player routes with what actually happened during the play, and thus indicate to the coach how often a player successfully ran a play or how often the player ran something completely different. This is important information for the coach in order to determine which players have studied their playbooks and have come prepared for the game

In some embodiments, the process stores the historical data from the game. This enables the rules to be applied to different time periods ranging from the beginning of the game to the current point in time. For example, a coach can see and evaluate how many times the team has been on offense and how many times the team has been on defense in a particular game, or a particular quarter of the game, and to see what was the most recent offense/defense. Other examples of information that is available to the coach is how many times there were penalties, personal fouls, extra points attempts at extra points, kick offs, and so on, depending on the sport. Since the information also specifies what players were in the game at any given point in time, the rules can also determine a score of what players perform the best together in the current game. This can help the coach in determining the best setup of players and thus increase the likelihood of having a successful game.

Next, the process determines whether to account for historical data from previous games (step 206). This can for example be done by asking the user of the software for further input. If no historical data should be accounted for, then the process proceeds to step 212, where the results from the application of the rules are presented to the user. The results can be presented in a number of ways, but are preferably presented in an easy to understand format, such as graphs or spreadsheets, allowing the user to make quick decisions based on the presented results.

If it is determined in step 206 that historical data from previous games should be taken into account, historical statistics are retrieved from a database (step 208), which may reside on the computer (108) or be accessible through remote access over a network. In the case of a football game, the database can be a database of NFL statistics of team and individual player information from previous games. These historical statistics to typically not include location data, but can still be a valuable addition to the location data that is recorded by the RFID readers (106) during the game. In some embodiments, the software also includes statistics about the players and plays for the opposing team B, in order to provide enhanced data for the current game. These statistics can also be available after the game, in which case the software can be used to simulate running particular plays against an upcoming opponent's possible defense. If all teams' information is made available, the coaches will have an easier time preparing for the next competition.

Next, the current location data obtained from the RFID readers (106) and the historical data retrieved in step 208 are combined (step 210). In some embodiments of the invention, the user can choose to put different weights on the current data and the historical data, for example, to place 80% emphasis on the current data and 20% on the historical data, and so on. This allows the coach to take into account various “anomalies” in the current game compared to previous games and get a better prediction. Finally, the result of the combination is presented to the user in step 212, as described above, which ends the process.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

A number of implementations of the invention have been described. Nevertheless, it will be understood that various modifications may be made without departing from the spirit and scope of the invention. For example, as an alternative to RFID, various other types of location sensing devices can be used, such as GPS (Global Positioning System) location information systems to determine the locations of the players. The location information above has been described with reference to various coordinate systems. However, other embodiments can use a single reference point or line, such as a specific yard line in a football field, and determine the players' relative location to this line and to each other. That is, rather than representing the location data as absolute coordinates, the location data can be represented as relative locations, such as Player A being two yards to the right and one yard ahead of Player B, for example. RFID tags can also be placed in the ball for ball sports, such as tennis, soccer, football, in order to obtain more data about the players' locations relative to the ball at any time, which can further approve strategic decision making and evaluation of various plays.

In addition to determining team effectiveness, the location information obtained by the RFID readers can also be used to determine, for example, a particular spot on the field where a player was tackled, whether a player has crossed a particular line, and so on. This information can also be transmitted to the officiator for the game, such that more specifics can be provided in the calls. The location information can also be transmitted to sports commentators, who can use their own analysis tools to predict what will happen next in a game or what team will win the game. In some embodiments, the location information can also be incorporated into television broadcasts, for example, by superimposing visual effects onto the images of players on the television screen, such as the players name, ranking, and so on. The location information can also be processed to automatically draw replay lines on the television screen, which today is done manually.

Another field in which the location information can be used is for computer game developers, which can access current location data and information about how a particular player moves and reacts in particular situations, rather than having to create the game based on old database statistics. This allows the computer game creators to create stronger real life user experiences, particularly in so-called live output games, where the players could get live feedback and realistic output on what would happen if they ran some play with a team. Accordingly, other embodiments are within the scope of the following claims.

1. A computer-implemented method for analyzing team effectiveness for a sports team, based at least in part on information obtained from an ongoing sports game, the method comprising:
generating location data by tracking a location for at least some players in the sports team during the ongoing sports game; and
processing the location data in real time in a computer to determine a team effectiveness for the sports team.

2. The method of claim 1, wherein generating location data includes:
tracking the location of the at least some players using a radio frequency identification tag for each of the at least some players and one or more radio frequency identification readers.

3. The method of claim 2, wherein each player's radio frequency identification tag stores at least one of the following data items: the player's name, the player's position in the team, statistics about previous games for the player, and various trivia about the player.

4. The method of claim 1, further including:
encoding the generated location data; and
transmitting the encoded data to a computer over a network.

5. The method of claim 1, wherein processing includes:
applying a set of rules to the received location data.

6. The method of claim 5, wherein the rules in the set of rules are specific to a particular sport.

7. The method of claim 5, wherein the rules in the set of rules are operable to evaluate a performance of the team as a whole during a particular time period of the ongoing sports game.

8. The method of claim 5, wherein the rules in the set of rules are operable to evaluate a performance of a specific combination of players in the team during a particular time period of the ongoing sports game.

9. The method of claim 5, wherein the rules in the set of rules are operable to determine whether a particular play was successful.

10. The method of claim 5, wherein applying a set of rules includes:
retrieving historical statistical data about one or more individual players from a database; and
accounting for the retrieved statistical data when applying the rules.

11. The method of claim 1, wherein the location data is provided as coordinates in a coordinate system specific to a field where the sports game is being played.

12. The method of claim 1, further including:
presenting the processed location data to the user in a graphical format on a device having a display.

13. The method of claim 1, further including:
transmitting the location data in real time to a public accessible network for further processing.

14. The method of claim 1, wherein processing the location data includes combining the location data with historical statistical data.

15. A computer program product comprising a computer useable medium including a computer readable program, wherein the computer readable program when executed on a computer causes the computer to:
generate location data by tracking a location for at least some players in the sports team during the ongoing sports game; and
process the location data in real time in a computer to determine a team effectiveness for the sports team.

16. The computer program product of claim 15, wherein the computer readable program when executed on a computer further causes the computer to:
encode the generated location data; and
transmit the encoded data to a computer over a network.

17. The computer program product of claim 15, wherein the computer readable program when executed on a computer further causes the computer to:
apply a set of rules to the received location data, wherein the rules in the set of rules are specific to a particular sport.

18. The computer program product of claim 17, wherein the rules in the set of rules are operable to evaluate one or more of: a performance of the team as a whole during a particular time period of the ongoing sports game, a performance of a specific combination of players in the team during a particular time period of the ongoing sports game, and whether a particular play was successful.

19. The computer program product of claim 15, wherein processing the location data includes combining the location data with historical statistical data.

20. A system for analyzing team effectiveness for a sports team, based at least in part on information obtained from an ongoing sports game, the system comprising:
one or more radio frequency identification tags, each radio frequency identification tag being associated with the physical location of a player in the sports game;
one or more radio frequency identification readers, the radio frequency identification readers being operable to:
determine the location of the one or more radio frequency identification tags;
read information stored in the one or more radio frequency identification tags; and
transmit the location and read information to a computer for further processing; and
a computer operable to:
receive the transmitted information from the radio frequency identification readers;
apply a set of rules to the received information in real time to analyze specifics of the ongoing sports game; and
produce a graphical output of the results from the analysis to a user on a display screen.
